(19) United States
(12) Patent Application Publication
(10) Pub. No.: US 2018/0341378 A1
(43) Pub. Date: Nov. 29, 2018

(54) COMPUTER-IMPLEMENTED FRAMEWORKS AND METHODOLOGIES CONFIGURED TO ENABLE DELIVERY OF CONTENT AND/OR USER INTERFACE FUNCTIONALITY BASED ON MONITORING OF ACTIVITY IN A USER INTERFACE ENVIRONMENT AND/OR CONTROL ACCESS TO SERVICES DELIVERED IN AN ONLINE ENVIRONMENT RESPONSIVE TO OPERATION OF A RISK ASSESSMENT PROTOCOL

(71) Applicant: Supered Pty Ltd., North Sydney, New South Wales (AU)

(72) Inventor: Hugh Morrow, New South Wales (AU)

(21) Appl. No.: 15/778,551

(22) PCT Filed: Nov. 24, 2016
(86) PCT No.: PCT/AU2016/051155

§ 371 Date: May 23, 2018

(30) Foreign Application Priority Data
Nov. 25, 2015 (AU) 2015904872
Nov. 25, 2015 (AU) 2015904875
Nov. 25, 2015 (AU) 2015904877

(51) Int. Cl. G06F 3/0484; G06N 99/00; G06F 9/451

(52) U.S. Cl. CPC G06F 3/0484; G06F 9/451; G06N 99/005

(57) ABSTRACT

Described herein are frameworks and methodologies configured to enable the provision of technology via online environments, for example in the context of technology in the field of user interface configuration and implementation. Some embodiments relate to delivery of content and/or user interface functionality based on monitoring of activity in a user interface environment, for example to enable staggered release of content and/or functionality based on monitoring of user competency levels, for example in respect of knowledge available for sharing via the user interface and/or in respect of utilization of the user interface itself. Other embodiments relate to controlling access to services delivered in an online environment responsive to operation of a risk assessment protocol, for example by enabling an automated determination in respect of whether to provide particular services (for example advice) to a given user of a web-delivered interface based on attributes of the user and/or processing of data representative of the user's historical interactions with the web-based interface.

### PRIORITY CLAIM

This application is a national stage application of PCT/AU2016/051155, filed on Nov. 24, 2016, which claims the benefit of and priority to Australian Patent Application No. 2015904872, filed on Nov. 25, 2015, and which claims the benefit of and priority to Australian Patent Application No. 2015904875, filed on Nov. 25, 2015 and which claims the benefit of and priority to Australian Patent Application No. 2015904877, filed on Nov. 25, 2015, the entire contents of which are each incorporated by reference herein.

### FIELD OF THE DISCLOSURE

The present disclosure relates in some embodiment to computer-implemented frameworks and methodologies configured to enable delivery of content and/or user interface functionality based on monitoring of activity in a user interface environment and in some embodiments to computer-implemented frameworks and methodologies configured to control access to services delivered in an online environment responsive to operation of a risk assessment protocol. Some embodiments of the disclosure have been particularly developed to enable staggered release of content and/or functionality based on monitoring of user competency levels, for example in respect of knowledge available for sharing via the user interface and/or in respect of utilization of the user interface itself. Some embodiments of the disclosure have been particularly developed to enable an automated determination in respect of whether to provide particular services (for example advice) to a given or designated user of a web-delivered interface based on attributes of the user and/or processing of data representative of the users historical interactions with the web-based interface. While some embodiments will be described herein with particular reference to those applications, it will be appreciated that the disclosure is not limited to such a field of use, and is applicable in broader contexts.

### BACKGROUND

Any discussion of the background art throughout the specification should in no way be considered as an admission that such art is widely known or forms part of common general knowledge in the field.

When designing a use interface environment, there is typically a balance struck between: (i) maintaining simplicity; and (ii) providing complex and/or advanced functionalities. This often results in a degree of compromise in terms of identifying a target audience; it is difficult to cater for a wide range of users of varying competency levels, and even more difficult to adapt as the user base increases in competency over time.

A particular technical problem arises where there exists a desire to exercise control over the accessing of particular user interface content and/or functionalities by particular users. In the case of a website, known technology tends to provide a “one-size-fits-all” user experience whereby substantially any user navigating to a particular URL are provided with substantially the same user interface content and functionality. A rudimentary partial solution to that problem involves applying access control to particular areas of a website, and managing user access codes thereby to manually control user access rights over those areas. Another approach to addressing this technical problem is to implement a prescribed learning pathway (for example a progressive set of tutorials or tasks). These possible solutions are limited in there adaptability, and may require substantial manual oversight.

Additionally, there are many situations where an online environment is used to automate processes that have conventionally been manual and labor intensive. In some cases, this creates risks to service providers, on the basis that it is challenging to monitor the operation of an automated process that is available in an open manner over the Internet to ensure that it is used “as intended”. One example is the provision of computer-generated advice (for example medical advice, education advice, or financial advice)—even a well-designed automated advice generation engine could provide wholly inappropriate advice due to peculiarities of a given user.

Although there are known sophisticated systems configured to provided automated advice, those systems rely on direct user inputs to generate the advice. That is, automated advice is generated based on information that the advice-receiving user actively provides, and accordingly there are a lack of safeguards in terms of the way a system might be manipulated to provide automated advice in an undesirable manner.

In the field of automated advice generation, there are therefore technical challenges associated with tailoring advice to particular users. Such technical challenges are accentuated because known automated advice systems are solely reliant on directly inputted information that defines attributes of a user. Accordingly, advice is not able to adapt to account for more subtle user attributes that the user may not wish to directly share (or might not be trusted to directly share). For example, this may include a degree of sophistication and/or underlying knowledge of a subject area.

Using conventional technology, automated advice is typically delivered to each of a plurality of different users based on data inputted by those users, so that two users that provide the same data inputs (and, for example, have corresponding demographic information) are inevitably provided the same advice. That can be particularly problematic, as the advice might be suitable for one of the users due to that user's level of sophistication, but unsuitable (and perhaps even dangerous) for the other one of the users.

### SUMMARY

According to a first aspect of the present disclosure there is provided a computer system configured to deliver a user interface to a plurality of client devices, the computer system including:
a user identification module configured to identify a user who accesses a user interface at one of the plurality of client devices;
a user interface monitoring module configured to interact with the user identification module and to monitor interactions between the user and the user interface;
a user activity component configured to operate a user activity rules engine operable to implement user activity rules configured to (i) identify predefined of the interactions between the user and the user interface; and (ii) in response to identification of a given or designated one of the predefined interactions between the user and the user interface, update interaction-derived values associated with the user based on at least one of the user activity rules associated with that given one of the predefined interactions; and
an interface customization component configured to operate an interface customization rules engine operable to implement interface customization rules configured to: (i) process the interaction-derived values updated in the user activity rules engine; and (ii) configure the user interface to control delivery of content and/or user interface functionality based on at least the processed interaction-derived values associated with the user.

According to a second aspect of the disclosure there is provided a computer system configured to configure a dynamically adapting user interface, wherein the user interface is configured to be delivered to a plurality of client devices, the computer system including:
a user interface management module that enables user-generation of a plurality of rules, including:
user activity rules configured to (i) identify predefined of interactions between a user and the user interface; and (ii) in response to identification of a given or designated one of the predefined interactions between the user and the user interface, update interaction-derived values associated with the user based on at least one of the user activity rules associated with that given one of the predefined interactions; and
interface customization rules configured to: (i) process the updated interaction-derived values; and (ii) configure the user interface to control delivery of the content and/or user interface functionality based on at least the processed updated interaction-derived values associated with the user.

According to a third aspect of the disclosure there is provided a computer system that is configured to deliver a user interface to a plurality of client devices, wherein delivering the user interface includes controlling delivery of content and/or user interface functionality to each of the plurality of client devices, the computer system including:
means for identifying a user who accesses a user interface, wherein the user accesses the user interface via code rendered via a web browser application that executes at a client device;
means for monitoring interactions between the user and the user interface;
means for operating a user activity rules engine, wherein the user activity rules engine is operable to implement user activity rules configured to (i) identify predefined interactions between the user and the user interface; and (ii) in response to identification of a given or designated one of the predefined interactions between the user and the user interface, update interaction-derived values associated with the user based on at least one of the user activity rules associated with that given of the predefined interactions; and
means for operating an interface customization rules engine, wherein the interface customization rules engine is operable to implement interface customization rules configured to: (i) process the interaction-derived values updated in the user activity rules engine; and (ii) configure the user interface to control delivery of the content and/or user interface functionality based on at least the processed interaction-derived values associated with the user.

According to a fourth aspect of the disclosure there is provided a user interface configured to control delivery of content and/or user interface functionality to each of the plurality of client devices, the user interface including:
means for identifying a user who accesses a user interface, wherein the user accesses the user interface via code rendered via a web browser application that executes at a client device;
means for monitoring interactions between the user and the user interface;
means for operating a user activity rules engine, wherein the user activity rules engine is operable to implement user activity rules configured to (i) identify predefined interactions between the user and the user interface; and (ii) in response to identification of a given or designated one of the predefined interactions between the user and the user interface, update interaction-derived values associated with the user based on at least one of the user activity rules associated with that given of the predefined interactions; and
means for operating an interface customization rules engine, wherein the interface customization rules engine is operable to implement interface customization rules configured to: (i) process the interaction-derived values updated in the user activity rules engine; and (ii) configure the user interface to control delivery of the content and/or user interface functionality based on at least the processed interaction-derived values associated with the user.

According to a fifth aspect of the disclosure there is provided a computer-implemented method for controlling delivery of content and/or user interface functionality, the method including:
identifying a user who accesses a user interface;
monitoring interactions between the user and the user interface;
operating a user activity rules engine, wherein the user activity rules engine is operable to implement user activity rules configured to (i) identify predefined interactions between the user and the user interface; and (ii) in response to identification of a given or designated one of the predefined interactions between the user and the user interface, update interaction-derived values associated with the user based on at least one of the user activity rules associated with that given of the predefined interactions; and
operating an interface customization rules engine, wherein the interface customization rules engine is operable to implement interface customization rules configured to: (i) process the interaction-derived values updated in the user activity rules engine; and (ii) configure the user interface to control delivery of the content and/or user interface functionality based on at least the processed interaction-derived values associated with the user.

According to a sixth aspect of the present disclosure there is provided a computer system configured to control access to services delivered in an online environment, the system including:
a user data management module configured to maintain a repository of user data, wherein the user data includes, for each user:
   (i) data representative of user personal attributes;
   (ii) data values inputted by the user via objects defined in the online environment;
   (iii) data representative of content accessed via the online environment;
a rating module that is configured to interact with the user data management module to perform a rating process that defines a rating for a given or designated user based on processing of data belonging to each of categories (i) to (iii) above; and
a service access control determination module configured to: (i) in the case that the rating meets threshold conditions for the given user, provide the given user with access to a controlled service via the online environment; and (ii) in the case that the rating fails to meet the threshold conditions for the given user, preventing the given user from accessing the controlled service via the online environment.

According to a seventh aspect of the disclosure there is provided a computer-implemented method for controlling access to services delivered in an online environment, the method including:
maintaining a repository of user data, wherein the user data includes, for each user:
   (i) data representative of user personal attributes;
   (ii) data values inputted by the user via objects defined in the online environment;
   (iii) data representative of content accessed via the online environment;
in response to predefined conditions being met by a given or designated user, triggering a rating process that defines a rating for the given user based on processing of data belonging to each of categories (i) to (iii) above;
in the case that the rating meets threshold conditions for the given user, providing the given user with access to a controlled service via the online environment; and
in the case that the rating fails to meet the threshold conditions for the given user, preventing the given user from accessing the controlled service via the online environment.

According to an eighth aspect of the disclosure there is provided a computer-implemented method for providing statistical modelling of future outcomes, the method including:
receiving input indicative of values inputted by a user via a user interface rendered at a client terminal;
based on the values, executing a modelling algorithm that is configured to predict a plurality of future outcomes for a forecast period; and
generating data configured to enable rendering of a graphic at the client terminal, wherein the graphic is representative of a one-dimensional distribution from a worst forecasted outcome to a best forecasted outcome, the graphic further including visual delimiters representative of at least two statistical probability levels, thereby to graphically distinguish three segments of the distribution.

According to a ninth aspect of the disclosure there is provided a computer system configured to provide statistical modelling of future outcomes, the method including:
a user interface data upload configured to receive input indicative of values inputted by a user via a user interface rendered at a client terminal;
a modelling module configured to, based on the values received via the input module, execute a modelling algorithm that is configured to predict a plurality of future outcomes for a forecast period; and
a graphic generation module that is configured to generate data configured define data to enable rendering of a graphic at the client terminal, wherein the graphic is representative of a one-dimensional distribution from a worst forecasted outcome to a best forecasted outcome, the graphic further including visual delimiters representative of at least two statistical probability levels, thereby to graphically distinguish three segments of the distribution; and
a user interface data download module configured to provide the data defined by the graphic generation module to the user interface, thereby to cause rendering of the graphic via the user interface.

One embodiment provides a computer program product configured to perform a method as described herein.

One embodiment provides a non-transitory carrier medium configured to carry computer executable code that, when executed on a processor, causes the processor to perform a method as described herein.

One embodiment provides a system configured to perform a method as described herein.

Reference throughout this specification to “one embodiment”, “some embodiments” or “an embodiment” means that a particular feature, structure or characteristic described in connection with the embodiment is included in at least one embodiment of the present disclosure. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given or designated sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

Additional features and advantages are described in, and will be apparent from the following Detailed Description and the figures.

### BRIEF DESCRIPTION OF THE DRAWINGS

Embodiments of the disclosure will now be described, by way of example only, with reference to the accompanying drawings in which:

FIG. 1A schematically illustrates a framework according to one embodiment.

FIG. 1B schematically illustrates a framework according to one embodiment.

FIG. 2 illustrates a method according to one embodiment.

FIG. 3 illustrates a client-server framework leveraged by some embodiments.

FIG. 4A illustrates a scoring schema according to one embodiment.

FIG. 4B illustrates a screenshot according to one embodiment.

FIG. 4C illustrates graphical objects according to one embodiment.

FIG. 4D to FIG. 4H illustrate graphical objects according to further embodiments.

### DETAILED DESCRIPTION

Described herein are frameworks and methodologies configured to enable the provision of technology via online environments, for example in the context of technology in the field of user interface configuration and implementation. Some embodiments relate to delivery of content and/or user interface functionality based on monitoring of activity in a user interface environment, for example to enable staggered release of content and/or functionality based on monitoring of user competency levels, for example in respect of knowledge available for sharing via the user interface and/or in respect of utilization of the user interface itself. Other embodiments relate to controlling access to services delivered in an online environment responsive to operation of a risk assessment protocol, for example by enabling an automated determination in respect of whether to provide particular services (for example advice) to a given or designated user of a web-delivered interface based on attributes of the user and/or processing of data representative of the user's historical interactions with the web-based interface. Further embodiments relate to aspects of a platform that provides statistical modelling of future outcomes, for instance in the context of delivering graphical information to a user, thereby to assist in understanding of complex future outcome forecasting scenarios.

It should be appreciated that, although some embodiments are described by reference to particular implementation environments (for example the provision of financial advice), it will be appreciated that the substance of various disclosures disclosed herein resides at the underlying technological level, for example the manner by which computer implemented methods are performed thereby to enable the delivery of underlying user interface platform functionalities. These are by no means limited by reference to abstract concepts in any particular field of business or the like.

Overview of Technical Solutions

In one embodiment, the inventors have developed technology whereby user interactions with a user interface (such as a website) are monitored over time, and a rules engine configured to dynamically cause modification of the way in which user interface pages are to be displayed to that user based on those interactions (for example in terms of providing additional menus, additional items in menus, additional navigation options, alternate information display protocols, and/or additional content/page links). More specifically, a two-layer rules-based process was developed, whereby: a user activity rules engine is operated in conjunction with an interface customization rules engine.

In the context of the user activity rules engine, a user interface management interface enables an administrator user to define user activity rules by specifying a form of interaction (for example visiting a particular page, interacting with an object, and so on), and an objective measurement for that interaction (for example duration of interaction, characteristics of inputs, and so on). The user interface management interface additionally enables the administrator user to define a protocol configured to update interaction-derived values in response to identification of a given or designated one of the predefined interactions of specified form and measure. These rules are stored in computer memory in a form that allows their execution by a user activity rules engine. The user activity engine operable to implement the defined user activity rules, thereby to (i) identify predefined of the interactions between a given or designated user and the user interface; and (ii) in response to identification of a given one of the predefined interactions between the user and the user interface, update interaction-derived values associated with the user based on at least one of the user activity rules associated with that given of the predefined interactions.

In the context of the interface customization rules engine, the user interface management interface enables an administrator user to define interface customization rules. For example, in an embodiment the user interface management interface enables the administrator user to define rules that are triggered and/or applied in response to the interaction-derived values associated a given or designated user. An interface customization rules engine is operable to implement interface customization rules configured to: (i) process the interaction-derived values updated in the user activity rules engine; and (ii) configure the user interface to control delivery of the content and/or user interface functionality based on at least the processed interaction-derived values associated with the user. Various forms of rules defining interfaces are optionally used, for example interfaces that provide functionality to graphically combine logical operators (for example IF/THEN/ELSE rules), trigger events, and so on.

By implementing a user activity rules engine in conjunction with a an interface customization rules engine, the technology described herein solves technical problems associated with exercising control over accessing of particular user interface content and/or functionalities by particular users. This is achieved in an automated manner, which enables a great deal of flexibility and adaptability in terms of the manner by which access is able to be granted in a progressive manner, but without the user prescriptively participating in an artificial progression of specified tasks (for example competing a tutorial, and then being provided access to a next tutorial). For example, user activity rules are able to be defined such that regular website utilization is autonomously monitored and quantified, thereby to enable automated determinations as to content/functionality delivery via interface customization rules. Accordingly, what is provided is a user interface that inherently implements a level of artificial intelligence over user interface functionality and content access that dynamically adapts over time based on administrator-defined rules, where the administrator defined rules are able to be defined using a wide range of possible forms of interaction.

In a further embodiment the inventors have developed technology that collects a broader base of information regarding a user, thereby to better tailor advice based on additional factors rather than just data inputted by those users. More specifically, the technology is configured to derive additional knowledge regarding attributes of a user (for example user sophistication) by performing background monitoring of a—user's interactions with an online environment, and combining that knowledge with other aspects of user data to selectively permit or deny access to particular automated advice generation processes (or to other controlled services more generally).

The technology disclosed herein additionally implements secondary processing of user inputs received in the context of information gathering for the generation of automated advice. Conventionally, such user inputs are subjected to primary processing in the context of determining content of automated advice that is generated. The secondary processing relates to determining whether or not the automated advice is to be delivered to the user, for example based on assessment of user sophistication. That is, an automated advice generation algorithm is configured to use a prescribed set of input values to determine characteristics of advice, and a rating process uses that same set of input values (in combination with other data) to define an advice risk rating (which is in some cases representative of estimated user sophistication) thereby to determine whether advice is to be delivered at all.

By implementing a computerized rating process that operates in response to automated triggers, the technology described exercises control over accessing of particular online services. This is achieved in an automated manner, which by which there is automated adaptation over time as a result of ongoing collection of user data (for example: data representative of user personal attributes; data values inputted by the user via objects defined in the online environment; and data representative of content accessed via an online environment). By such an approach, the technology provides a flexible and adaptable framework to control access to services without manual intervention—attributes stemming from user online activity automatically influence subsequently triggered service access determinations.

In a further embodiment, technology described herein relates to the operation of computing systems to deliver complex statistical models via a limited screen footprint. This is particularly relevant to statistical modelling whereby a large number of scenarios executed via modelling software, these resulting in a statistical distribution of potential future outcomes. In addressing technical challenges associated with displaying complex modelling information via a limited screen footprint, the inventors have identified that computer graphics are able to construct a one-dimensional distribution representative of modelled future outcomes, and provide a practically useful consolidation of key information by applying a pair of statistically defined delimiters to that one-dimensional distribution. As context, computer technology configured to enable future modelling of real-world outcomes based on defined conditions and forecasting algorithms is well established, and continues to develop. However, there are inherent technical challenges associated with the delivery of modelling data to human users in an easily understandable form. For example, common techniques often require delivery of a numerous related charts (for example statistical distribution plots). Technical challenges arise in the context of delivering complex modeming data where there is a limited screen footprint in which to display graphical information (for example in the context of data delivered via mobile devices). In particular, conventional information display approaches (for example traditional Monte Carlo style probability charts) can be far to detailed and complex for delivery via a limited screen footprint.

Activity Monitoring Driven User Interface

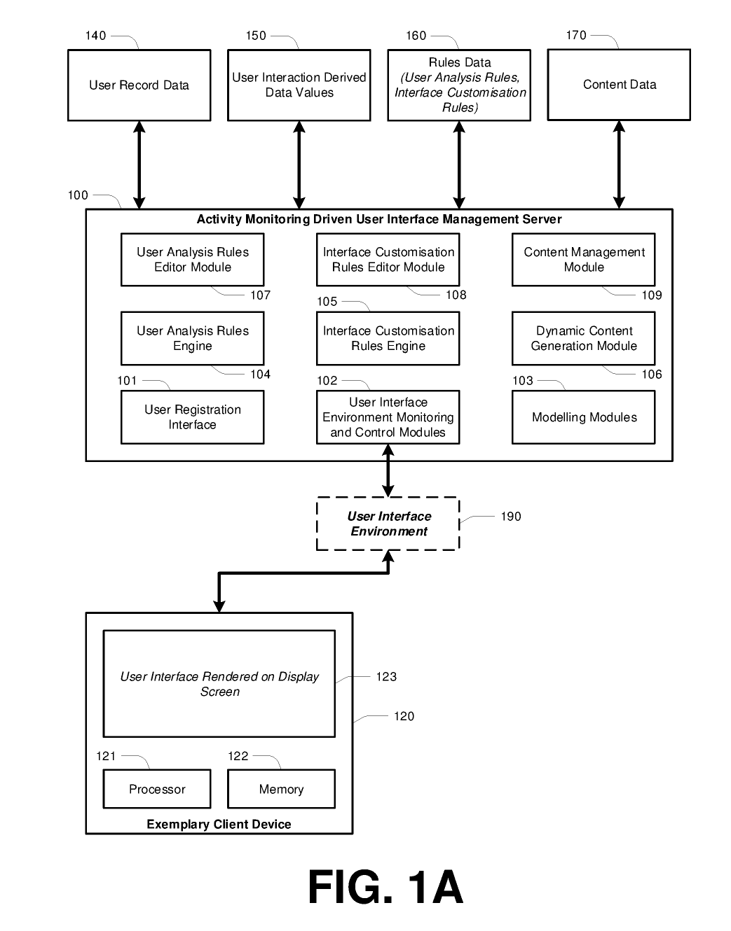

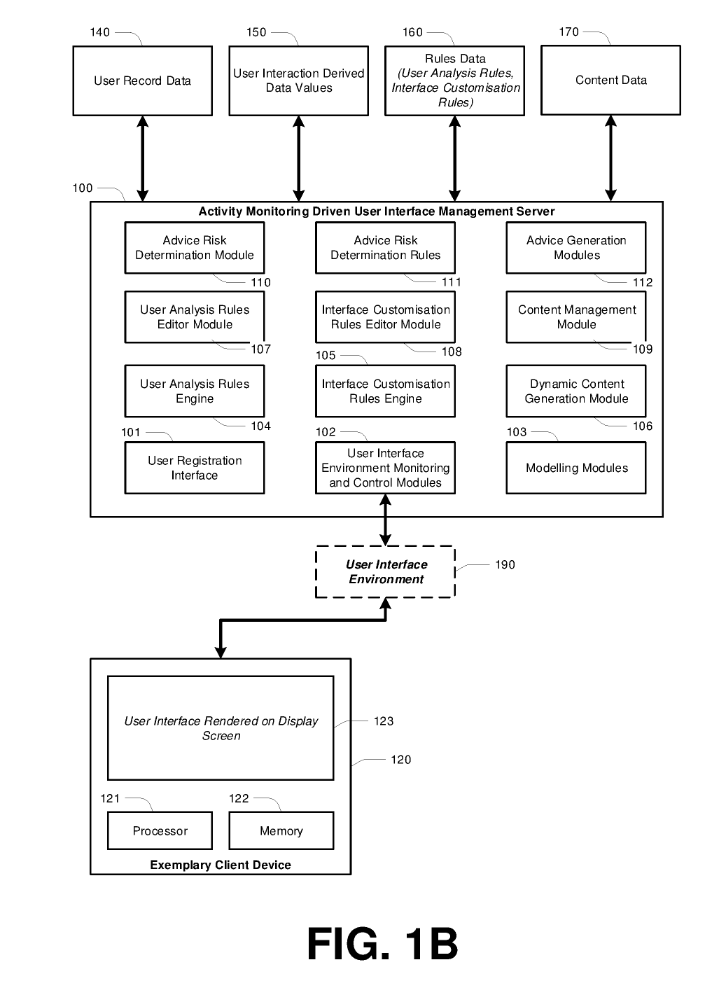

Embodiments are described by reference to an activity monitoring driven user interface, and associated framework, is illustrated in FIG. 1A. This interface is configured to enable monitoring of user interactions, which becomes relevant in the context of making determinations with respect to accessing of controlled services such as automated advice.

The interface of FIG. 1A is “activity monitoring driven” in the sense that functionalities relating to the delivery of content and/or user interface functionality are based on monitoring of activity, and more specifically based on monitoring of user activity in the user interface environment Components illustrated in this diagram (such as interfaces and modules), and other diagrams provided in conjunction with the present description, are not representative of individual distinct software programs; rather the framework is described by reference to functionally identifiable components, which in various embodiments are delivered collectively via one or more software applications.

In overview, the framework of FIG. 1A is configured to operate processes that (i) identify predefined interactions between a user and the user interface; and (ii) in response to identification of a given or designated predefined interaction between the user and the user interface, configure the user interface to enable provision of specified content and/or user interface functionality.

An activity monitoring driven user interface management server 100 is configured to interact with a plurality of client devices, including an exemplary client device 120, which is intended to be generically representative of substantially any form of client device. The client devices may include substantially any computing devices, including desktop computers, laptop computers, tablets, smartphones, gaming devices, and the like. The client devices each execute respective software applications that enable the local rendering of user interface components which facilitate interaction between a local user and server 100. In FIG. 1A, this is illustrated schematically by reference to a user interface environment 190. User interface 190 is illustrated between client device 120 and server 100 to indicate that user interface may be provided via code executing at either or both of those devices, and/or by code executing at one or more further locations (for instance web servers). By way of example, client devices may provide such user interface components via: (i) a web browser application, which is configured to download user interface components from one or more web servers, and render those to provide the user interface components; or (ii) a proprietary locally executing software application (such as a mobile app operating on iOS or Android) which is inherently adapted to maintain a communication channel with server 100. Client device 120 includes a processor 121 configured to execute software instructions maintained in a memory unit 122 (for example software instructions representing a web browser application or a proprietary locally executing software application), thereby to render a user interface on a display screen 123.

A set of user interface environment monitoring and control modules 102 functionally provide a link between server 100 and user interface environment 190. In particular, these modules enable monitoring of activity within the user interface environment (such as activity by the user of client device 120), and enable controlling of the user interface (for example instructions in terms of content to render).

A user of client device 120 interacts with server 100 via environment 190 thereby to login via a defined user account (and, where relevant define a new user account via a user registration interface 101). The login process need not be a distinct manual process in all cases, with technology such as cookies and stored credentials being used to enable background user identification. Each user is associated with identification data (for example a username and password), along with other personalizing information (such as age, income, address, and so on, depending on what is required in a given or designated field if implementation). This is maintained in a repository of user record data 140.

As used herein, the term “activity”, insofar as it pertains to activities that may be monitored in a user environment, is to be afforded a broad interpretation. A representative selection of monitorable activities are outlined below:
Interactions with content segments rendered via the user interface (for example a content page, article, text box, or the like). For example, interactions may include time spent viewing a given or designated content segment, identifying that the end of a segment has been reached, interaction with a call-to-action provided in association with a given content segment, null interactions, and so on.
Interactions with GUI objects, such as scroll bars (for example monitoring scroll rates and/or patterns), buttons, check boxes, videos (for example whether a video was accessed, played in full, etc.), and so on.
Interactions observed via audio monitoring. This may include monitoring of active audio input, and/or monitoring other audio such as background noise (which may, for instance, be indicative of the extent to which a user is paying full attention to displayed content). In one embodiment the framework is configured to rate/distinguish interactions based on a level and/or categorization of background noise.
Interactions observed via video and/or other forms of direct user monitoring. An example is monitoring via eye tracking or the like, to better assess whether a user is effectively reading written content. In one embodiment the framework is configured to rate/distinguish interactions based on observed eye movements.
Interactions observed through input devices (Mouse, cursor or trackpad, keyboard, etc)
Null interactions (for example where there is no interaction in a predefined manner).
Combinations & patterns of inputs over time (for example the rate of mouse movement/keystroke, consistency of the rate of movements).
Combinations & patterns compared to:
   previous combinations and patterns generated by the user in previous logins; and/or
   other users.

Of course, this is by no means intended to be an exhaustive list.

The term “content segment” is used to describe a discrete portion of content, such as text, image, or other media. The term “segment” is used to differentiate from an individual content page. Multiple content segments may be stitched together to provide content on a single “page” (for example a web page, or a page defined in a software application). In some embodiments multiple content items are stitched together based on a content identification process. This process may be dynamic, in that additional content is added to a viewed page based on determinations made after initial rendering. For example, a determination of how well a user has understood a given content segment (for instance based on a call-to-action response or viewing time) may have an effect on the next content segment that is selected for display. In the illustrated embodiment a dynamic content generation module 106 is configured to define user interface renderable data based on one or more content segments (including text, media, and so on). Content is stored in a repository of content data 170, and a content management module 109 assists an administrator-level user in uploading content in a standardized form such that it is available for incorporation in the user interface environment (for instance via age generation via content generation module 106).

Activities such as those above are identified thereby to affect user interface operation. More specifically, computer processes execute (in FIG. 1A being at the server side, but at further embodiments alternately wholly or partially at the client side) to enable: (i) identifying a user who accesses a user interface, for example based on a database of user data and/or a login event; and (ii) monitoring of interactions between the user and the user interface (for example using one or more of the classes of monitoring set out above).

Monitoring of activities affects user interface operation via delivery of content and/or user interface functionality. The use of “and/or” is to indicate that in some embodiments the affecting is in terms of delivery of content to the exclusion of user interface functionality, in some embodiments the affecting is in terms of user interface functionality to the exclusion of delivery of content, and is in some embodiments the affecting is in terms of both delivery of content and user interface functionality (although not necessarily simultaneously).

Examples of techniques for controlling delivery of content include:
Determining that a particular content segment is to be displayed, or that a particular element of computer generated content (such as a video, embedded object, image, email or the like) is to be displayed.
Determination that a particular content segment is to be made available for accessing via a content selection interface (for example via a hyperlink in a “related content” page area).
Determination that a particular content segment is to be withheld from becoming accessible.
Promoting a particular content segment (via means defined within the user interface, such as a prominent display object; or via means external to the user interface, such as email or social media advertising).
Determining that a particular content segment is to be delivered via a standalone page (as opposed to with other segments); with or without one or more call-to-action objects (for example multiple call-to-actions may be used where a prediction is made that such objects are required to cause user attention to details); via a particular media type (such as video as opposed to text for a user who is identified as having a tendency to watch videos from start to finish).
Determining that a particular content segment is to be delivered via a particular medium, such as, email, online chat, video, audio, text or graphic communications channel/media.

This is by no means intended to be an exhaustive list.

Examples of techniques for controlling delivery of user interface functionalities include:
Determination that a particular user interface object is to be displayed.
Selection of objects to be made available via a menu area (for example a sidebar menu).
Selection of forms of user interface components that are to be made available.
Determinations to allow/restrict access to particular user interface functionalities, such as access to services.
Enabling rendering of a graphic having a defined level of detail. For example, a particular graphical object or class of graphical objects may be renderable at varying levels of detail. An example is a chart or diagram, to which additional information is added as the level of detail increases.
Providing access to a condensed user input content page, other page, or other form of input object arrangement. For example, a user is initially presented with a user input objects in conjunction with respective instructions and/or contextual information (for example plurality of user input objects over a plurality of pages, with each page providing instructions and/or contextual information). Subsequently, the user is provided access to a condensed user input page, where the user input objects are provided in a condensed for without the same level of instructions and/or contextual information.
Providing access to an advanced user input content or other page or other content page, other page, or other form of input object arrangement. For example, a user is initially presented with a user input objects that provide a limited range of input functionalities, and the range of available input functionalities increases over time based on the monitoring (for example as the user gains additional competencies).
Customizing computer generated content page (or other content) to provide one or more particular navigation objects.
Providing access to an interactive modelling platform, for example as discussed further below.
Providing access to automatically generated advice. This is also discussed further below, in the context of embodiments where automatically generated advice is restricted subject to an automated form of risk assessment.

Again, this is by no means intended to be an exhaustive list.

As noted above, the framework of FIG. 1A is configured to operate processes that (i) identify predefined interactions between a user and the user interface; and (ii) in response to identification of a given or designated predefined interaction between the user and the user interface, configure the user interface to enable provision of specified content and/or user interface functionality. More specifically, these processes are implemented via two levels of rules: a user activity rules engine 104 (referred to as a “user analysis rules engine” which implements “user analysis rules”) which updates user data based on monitoring; and an interface customization rules engine 108 (referred to as a “interface customization rules engine” which implements “interface customization rules”) that makes determinations as to delivery of content and/or functionality based on the user data. In the illustrated embodiment rules for both rules engines are stored in a rules data repository 160. However, it should be appreciated this, and others of the illustrated data repositories, may be defined by a greater number of individual repositories, and/or aggregated into a fewer number of repositories. As illustrated, the data repositories are functionally distinguished only.

Although two rules engines are disclosed, it should be appreciated that in practice these may be defined by an alternate number of rules engines, or by a plurality of software modules that are configured to collectively provide functionality corresponding to that of the two rules engines described.

User analysis rules engine 104 is operable to implement rules configured to (i) identify predefined interactions between the user and the user interface; and (ii) in response to identification of a given predefined interaction between the user and the user interface, update defined data values. More specifically, the data values are updated based rules associated with predefined interactions. In the embodiment of FIG. 1A these are interaction-derived values maintained in user data associated with the user.

The association between rules and predefined interactions is by no-means one-to-one. There may be multiple rules associated with a given or designated interaction (for example identification of a given interaction may trigger multiple rules), and a given or designated rule may be associated with multiple interactions (for example a given rule is triggered responsive to multiple specific interactions, either individually or in combination).

In certain embodiments, an administrator-level user is provided with a user interface that enables rule generation (see user analysis rules editor module 107), for example by enabling generation of a definition for the interaction (or interactions) to which the rule applies, and a protocol configured to update specific data values based upon the observed interaction or interactions (or in some cases attributes of the observed interaction or interactions). For example, the rules are defined using a range of logical operators (such as IF, AND, THEN, ELSE and OR operators). Rules editor module 107 provides a graphical user interface, which is renderable on a display device of a terminal operated by an administrator-level user, and this graphical user interface provides components that enable the administrator-level user to define both user activity rules and interface customization rules based on all or any subset of any of the examples provided herein (and in further embodiments based on additional factors that are not disclosed herein). In certain embodiments, this includes a rules builder interface, which allows a user to select from available “rule artefacts” (such as forms of monitorable interaction, particular modifiable interaction derived values, and so on), quantifiers (for example measures for forms of monitorable interaction, and amounts by which interaction-derived values are to be varied), and logical operators. This provides a flexible tool by which the administrator-level user is able to construct rules from available system artefacts and data. The set of available rule artefacts is, in certain embodiments, expanded over time thereby to provide additional flexibility for additionally complex and/or specifically customized rules. In further embodiments a machine learning module is configurable to optimize one or more rules or rule sets over time based on ongoing observations.

In certain embodiments, the interaction-derived values include “competency scores”. A “competency score” is a value representative of a user's competency in a particular topic (which, for example, may be a topic relevant to subject matter that is taught by the user interface, or a topic relevant to utilization of the user interface itself). The user analysis rules engine is in some embodiments configured to implement rules of any of the following forms: a rule that increases a specified competency score in response to identification of a predefined interaction; a rule that decreases a specified competency score in response to identification of a predefined interaction. In some cases multiple competency scores are affected by a given interaction.

In some embodiments, rules are defined in relation to particular content, for example in relation to content segments, or defined presentations/collections of content segments. As context, such an arrangement is particularly useful where the affected data values are competency scores. Specifically, an administrator-level user generates or reviews a particular piece of content, and determines how that piece of content, if understood by a reader, enhances (or validates) their competency in one or more topics. The user may then define a scoring protocol for that piece of content, for example it may be worth a defined number of points against each of a plurality of competency score items.

In some cases scoring for a given or designated piece of content is based upon completion: in the case that a user “completes” the content, then scores are awarded. In that regard, a rule is set to define what is meant, in terms of observable user interactions, by “completion”. For example, a user may have to perform one or more of the following forms of interaction: (i) spend a threshold amount of time; (ii) scroll to the end at less than a threshold rate; (iii) interact with one or more call-to-action objects; and (iv) watch a video or animation in its entirety.

In some embodiments, there are multiple definitions of “completion”, which are each associated with a respective award of scores. For instance, observation of certain user interactions is representative of completion with predicted high-efficacy learning, and observation of other user interactions is representative of completion with predicted medium-efficacy learning. This may be the difference between a user who spends greater than 5 minutes on a content piece, and repeatedly scrolls back up to re-read content, and a user who reaches the end in less than one minute with unidirectional scrolling.

In some embodiments definitions for “completion” are defined generically to apply across a range of content items independent of their specific content. For example, specific content is authored, and that is formatted for delivery/rending in one of a plurality of standardized forms for which completion definitions and associated interaction monitoring processes are predefined.

In some cases the scoring is binary: points for completion and no points where there is no identification of completion. In some cases the scoring is more complex, for example awarding negative points for “failure”, a null award for “non-completion” and a full award for “completion”. There may, in still more complex cases, be additional granularity between “failure” and “completion” which affects scoring.

In the embodiment of FIG. 1A, competency scores and other interaction derived values are stored in a data repository 150.

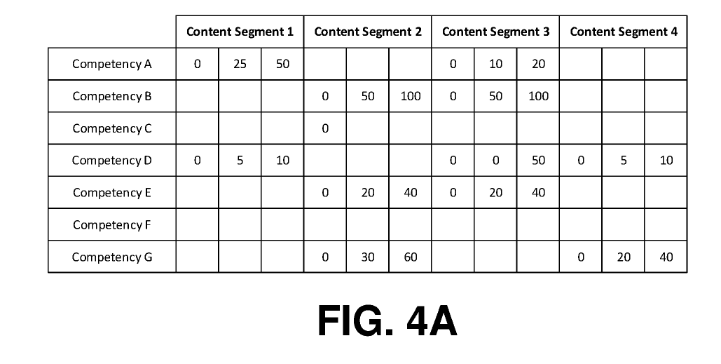

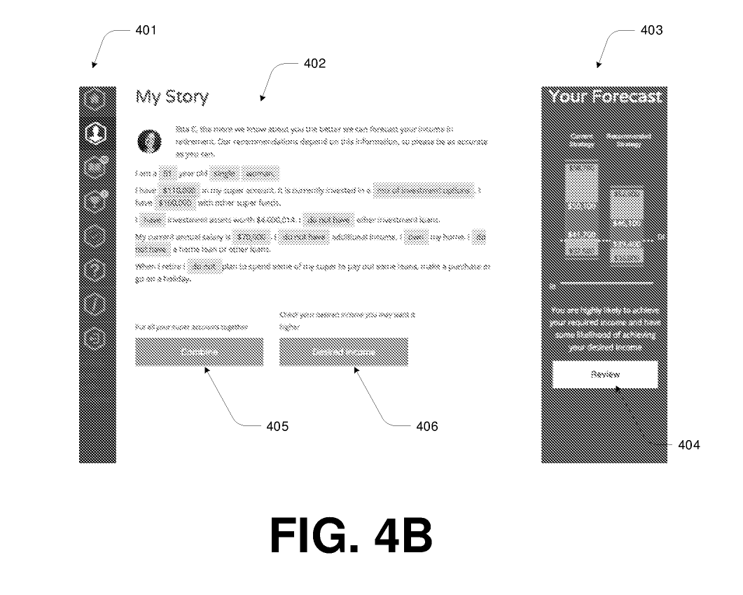

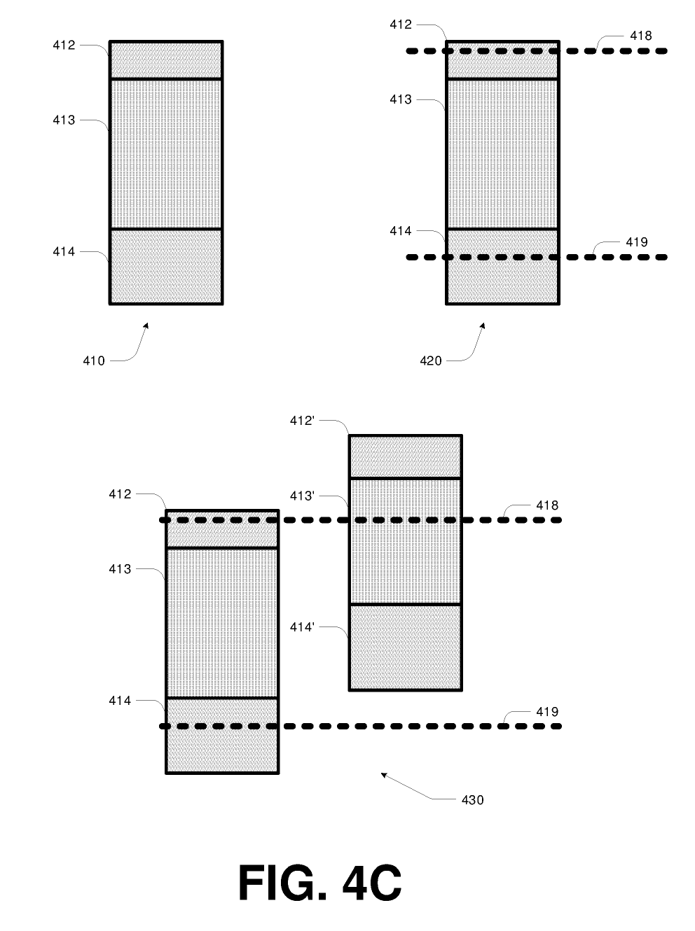

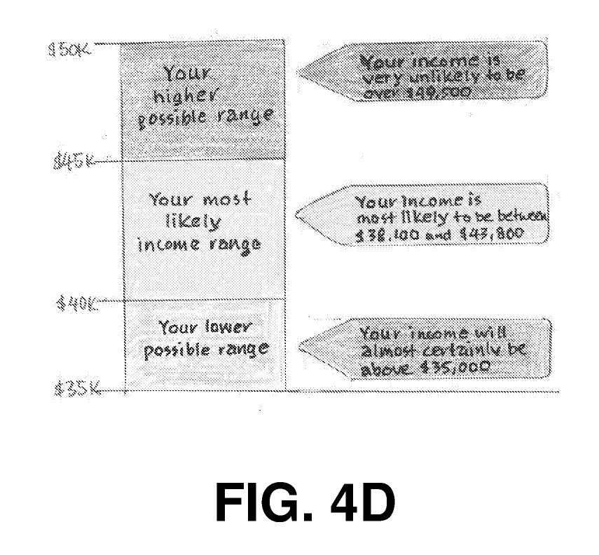

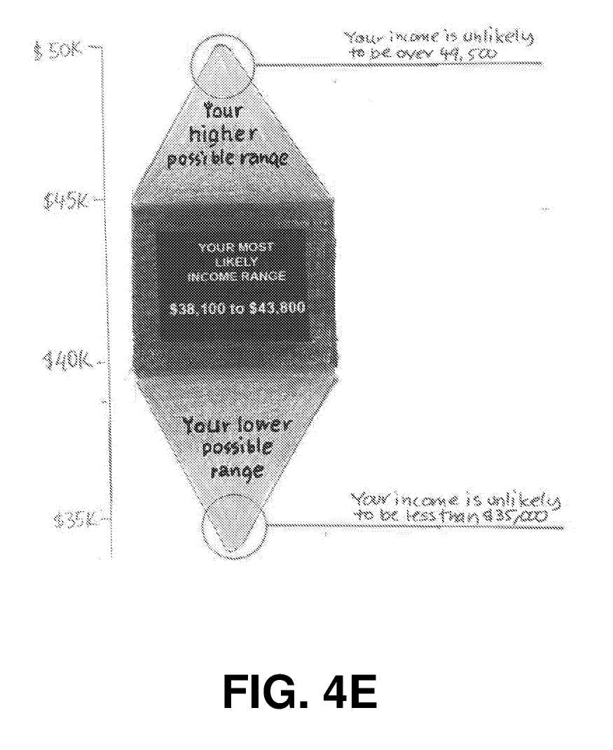

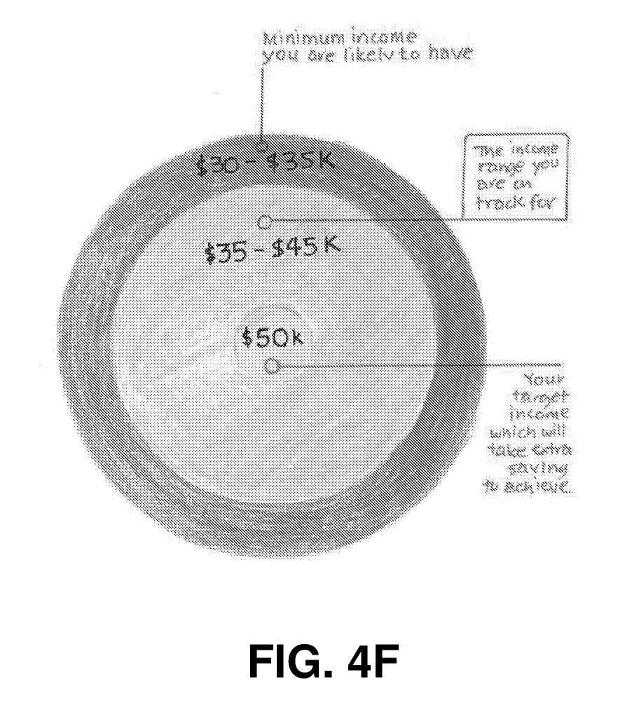

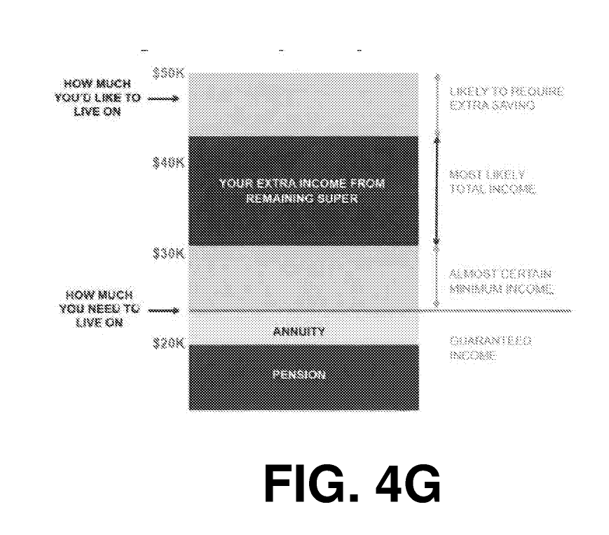

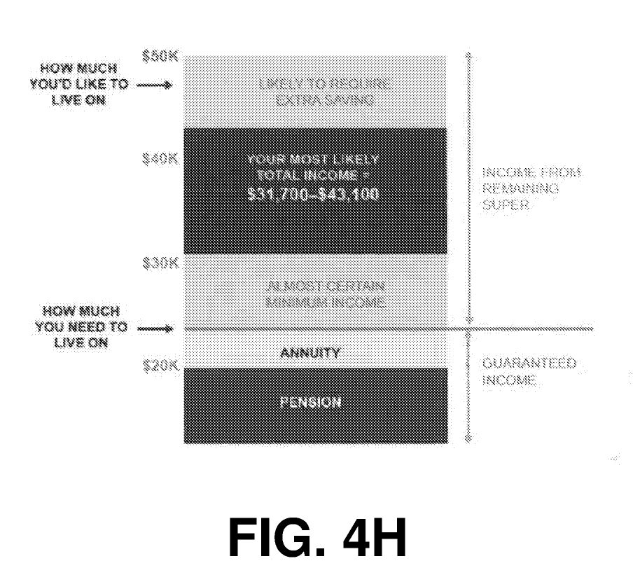

FIG. 4A illustrates a table showing scores available in relation to a plurality of content segments (Content Segment 1 to Content Segment 4) for a set of competencies (Competency A to Competency G). For each content segment and each competency, there is an available score associated with: non-completion; low-effectiveness completion; and high effectiveness completion. Definitions as to predefined interactions leading to each level of completion are defined, for example by reference to time spent, call-to-action response, and so on.

In some embodiments a learning algorithm is implemented to observe user behaviors for a given user, and make determinations as to forms of content with which the user preferentially engages (for example some users will choose to watch videos in preference to reading text, whereas other users will not watch videos), and tailor the delivery of content segments based on an automated predictive determination of the user's preferred media types. This learning algorithm in some embodiments is configured to perform an optimization process based on observation of user content completion rates (optimizing to increase content completion rates).

The interface customization rules engine 108 is operable to implement rules configured to: (i) process interaction-derived values associated with the user; and (ii) configure the user interface to enable provision of specified content and/or user interface functionality. The rules implemented by the interface customization rules engine.

In various embodiments, the interface customization rules engine uses other rule input values in addition to interaction-derived values (such as competency scores). These may also in some embodiments be used by the user analysis rules engine. Examples of such other rule input values include:
User known attribute data. For example, this includes data maintained in user data 140 inputted by the user such as age, location, marital status, income, medications, and so on.
User inferred attribute data. For example, rules are defined to enable inferences with respect to unknown user attributes based on user attributes (for example IF attribute A in range Y AND attribute B in range X, THEN set attribute C to value Z). This is optionally used to make further predictions about a user based on demographics, observations and the like. An example may include life expectancy prediction, prediction that a user may have children in coming years, and so on.
User segmentation data. Based on monitoring of user interface interactions, known/inferred attributes and/or other inputs, users may be associated with particular predefined “segments”. Segments are optionally used to objectively categorize users based on observations for example by reference to factors such as: level of engagement with the user interface; attitude towards a particular issue (such as money or health); media consumption preferences; attention span; and so on. It will be appreciated that segments and rules configured to associate a user to segments may be defined on an ongoing basis to better tailor rule generation for the first and interface customization rule engines.
Segment/cohort profile norms. In this regard, some data may be inferred based on the segmentation, for example rules that enable automated implementation of an observation such as “users like this tend to have X, Y and/or Z”.
Interactions such as those identified in as exemplary activities further above.
Data values inputted by a user via user interface objects (such as toggles, sliders, menus, input fields, end so on).

One functionality of the interface customization rules engine is enabling relevant content prediction. As context, there are multiple situations where a user's actions in a user interface trigger the selection of new content for rendering. For example, this occurs where a user completes a section of rendered content, navigates to a new page, and so on. One or more rules implemented by the interface customization rules engine may result in selection of that new user interface content. For example, this enables prediction of a next relevant piece of content upon a user's completion (or navigation away from) a current piece of content. Such rules are optionally defined by a trigger event (for example “WHEN user completes Content Piece A”), one or more conditions (for example “IF user has competency score A greater than value B AND IF user has age value of greater than value C) and an outcome (for example “RENDER content segment X and content item Y using presentation schema Z” or “NAVIGATE to page 1234”).

In certain embodiments, relevant content prediction is performed upon a user login (which need not involve a manual login; a user may be autonomously recognized using cookies, user activities, tokens or the like), such that a user is immediately directed to the next price of predicted relevant content. For a new (or relatively new) user, content prediction rules may be based upon known and/or inferred attributes only, as there would be little data available from operation of the user analysis rules engine. In some embodiments inferences (such as segmentation) are used to set initial predicted competency scores and the like.

Another functionality of the interface customization rules engine is making content available. For example. This may also be triggered upon completion of a given piece of content, although various further triggers may be used (for example receipt of data inputted via a specific user interface object). Such content may be made available by way of display in a menu, for example a “related articles” menu or the like.

Another functionality of the interface customization rules engine is making user interface functionality available. This may include rules that, when triggered, cause additional user interface menus and menu items to be made available, and/or additional user interface services to become accessible. A further example is providing access to data modelling functionality provided via modelling modules 103, which may provide modelling functionalities discussed further below.

FIG. 4B illustrates an exemplary GUI screenshot illustrating content and functionalities that are able to be affected by interface customization rules. These are:
A sidebar 401. Additional items are added to the sidebar as user competency increases, for example by: (i) adding new items upon a user gaining a level of technical competency required to appreciate the associated technical content; and (ii) adding new items as the user gains more competency in overall user interface environment utilization (in some cases each new item is introduced via tutorial content).
An input interface 402. This input interface enables a user to [symbol] personal values into a plurality of data fields. These may be pre-populated based on known information. The number of fields may vary over time based on operation of interface customization rules.
A forecast graphic 403. This may be illustrated at varied levels of detail, based on operation of interface customization rules, as shown in FIG. 4C.
Further content navigation buttons 404, 405, and 406, which are selected for rendering based on operation of interface customization rules.

Another optional functionality of the interface customization rules engine is making additional content graphical content available, for example enabling rendering of a graphic having a defined level of detail. For example, a particular graphical object or class of graphical objects may be renderable at varying levels of detail. An example is shown in FIG. 4C, which shows three levels of detail for a given or designated graphic. In this example, a graphic at a first level of detail 410 is defined by a bar having portions 412, 413 and 424. Ata second level of detail 420 the graphic is enhanced to include two indicator lines 418 and 419. For example, these are introduced once a user has an observed level of competency in topics required to understand the meaning and significance of those indicator lines. Then, at a third level of detail 430, a second bar having portions 412′, 413′ and 414′ is added, this for example providing a comparison between a first scenario (for example a current modelled scenario) and a second scenario (for example a recommended strategy that is also modelled). This level of detail may be reserved for users who have adequate levels of competency to understand context underlying a recommended strategy.

An interface customization engine rules editor module 108 is provided, thereby to enable a user to define new rules for the interface customization rules engine. This, for example, enables rendering via an administration level user interface of user interface objects that enable selection of rule attributes such as triggers, conditions and actions. As with user analysis rules, a machine learning algorithm may be implemented thereby to perform automated rule generation and/or optimization based on monitoring of performance of the rules within the framework as a whole across a large number of users.

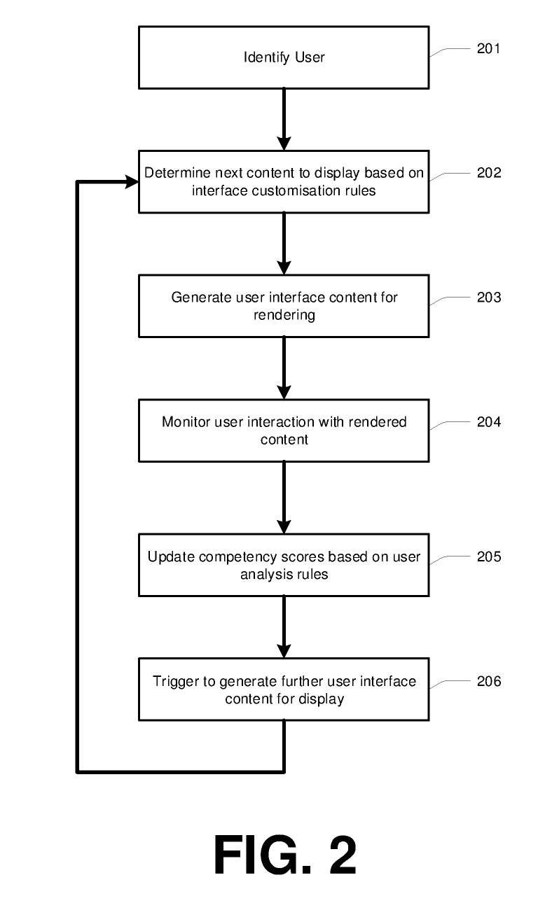

FIG. 2 illustrates a method according to one embodiment. It will be appreciated that this method describes process flow or an exemplary use case, thereby to provide a practical example of how the above technology operates in practice. Such a user case may, in practice, be implemented across any one or more of the following fields of application:
Medical treatment. As a user develops a greater understanding of underlying concepts, health, and/or treatment risks, the user is provided with additional information and medical treatment advice. For example, in one embodiment a prescription for medication is able to be obtained once a user has demonstrated by way of interaction with the online environment that they have adequate competencies in relevant topics to be trusted to use the medication in an educated and sensible fashion.
Equipment maintenance. A user is provided with information that assists in performing more complex maintenance tasks only where they have demonstrated competency (for example through interaction with content) in respect of simpler underlying tasks of which prior competency is recommended.
Financial advice, such as in the context of superannuation. Content of increasing complexity regarding financial management is delivered to a user over time based on observation and updating of competency levels, to better ensure that the user is able to understand concepts and reasons underlying suggestions and/or advice.
General education. Competency scores are used to enable a more graduated system of ensuring a user has adequate prerequisite knowledge for a particular course or content based upon monitoring of what a user has learned (or demonstrated knowledge of) via their use of the online environment.

Block 201 represents a process including identifying a user of a user interface environment, for example via a manual login for automated means (such as use of cookies). This provides a trigger to determine initial content for display via the user interface, for example in terms of user interface objects and one or more content segments. This is achieved at block 202 based on operation of the interface customization rules, which determine content and/or user interface functionality that is to be provided based on data maintained for that user, which includes data derived from analysis of previous interactions with the user interface environment. Based on that determination, block 203 includes generating user interface content for rendering at the client device.

Block 204 represents a process including monitoring user interaction with rendered content, for example time spent viewing a given or designated content segment, interactions with GUI objects, and so on. This is used at a process represented by block 205, which includes updating competency scores (and optionally other values) based on user analysis rules.

Block 206 represents a process including a trigger to generate further user interface content. This may be content that is added to an existing page object (for example a further content segment), or content that replaces that which is shown in an existing page object. In response to that trigger, the method loops to block 202.

As an alternative to a navigation-related trigger, in some embodiments changes are dynamically made based on the operation of interface customization rules, for example rules that cause the rendering of navigation objects that enable a user to select a next category of content to view (for example by clicking one of a plurality of available buttons generated based on the interface customization rules). In some examples such buttons only appear on a given or designated display page upon rules for content segment completion being satisfied.

It will be appreciated that the use of a user analysis rules engine in combination with an interface customization rules engine as described above enables powerful dynamic customization in terms of user interface and user experience, for example based on determination of a user's increasing competencies in various skills and topics that re developed within the user interface itself. This allows a user interface to in essence grow with a user; it may begin by providing relatively basic content and functionality, and incrementally grow in line with the user's own progression cycle. In this manner a single user interface may be both simple and substantially infinitely complex, with the level of complexity presented to a particular user being tailored in real time to that particular user's perceived readiness for such complexity. This is especially useful in terms of delivering educational material, and, as described below, ensuring that a user has threshold levels of competency to receive certain information and/or advice.

Controlling Access to Services Based on a Risk Assessment Protocol

FIG. 1B illustrates a framework according to an embodiment, this being a framework relating to controlling of access to services based on a risk assessment protocol. This is illustrated as an enhanced version of the framework of FIG. 1A, including all components of FIG. 1A. However, it will be appreciated that functionalities unique to FIG. 1B may be performed in alternate frameworks which exclude one or more functionalities present in FIG. 1A.

In overview, controlling of access to services based on a risk assessment protocol is applied in circumstances where there is a desire to prevent a user from accessing certain web-delivered services unless a degree of user validation (for example competency and reasonableness validation) has been performed. Technology underlying the framework of FIG. 1B enable such a determination to be made in an automated and objective manner. The crux of the technology is a method including maintaining one or more repositories of user data, wherein the user data includes, for each user:
(i) Data representative of user personal attributes. For example, this may be provided in whole or in part via data 140. This may additionally include segmentation data and/or inferred data as discussed further above.
(ii) Data values inputted by the user via objects defined in the online environment. For example, this may include data inputted via input fields (for example see item 402 in FIG. 4B), toggles, sliders, and so on. This is in the illustrated embodiment also stored in user record data 140, although in further embodiments the inputted data values are maintained in an alternate location.
(iii) Data representative of content accessed via the online environment. For example, in the example of FIG. 1B, this includes user competency scores derived through interaction monitoring as described further above. However, this is by no means limiting, and in further embodiments alternate approaches are used to determine content that has been accessed by a given user.

In some embodiments the data also includes: (iv) data representative of interactions between the user and a user interface, for example as discussed further above.

The method then includes, in response to predefined conditions being met by a given identified user, triggering a rating process that defines a rating for a user based on processing of data belonging to each of categories (i) to (iii) above (and, where relevant, category (iv). In the case that the rating meets threshold conditions for the given user, providing the given user with access to a controlled service via the online environment. In the case that the rating fails to meet the threshold conditions for the given user, preventing the given user from accessing the controlled service via the online environment.

The above approach is optionally applied for the purpose of restricting access to computer generated advice. For instance, an advice risk determination module 110 operates on the basis of a set of predefined advice risk determination rules 111 thereby to calculate rating which includes (or is defined by) an advice risk rating. A user with a greater-than-threshold advice risk rating is granted access to functionality provided by advice generation modules 112.

The purpose of advice risk determination is to autonomously and objectively determine whether a given user, based on their known attributes and interactions with a user interface environment, is deemed to be appropriate to receive computer-generated advice. There are a number of factors that affect whether a user is deemed as appropriate to receive computer generated advice, for example:
Competency in given or designated topics relevant to understanding of the advice. Competency may be determined via interaction monitoring, as described above. In further embodiments alternate means for assessing competency are used, for example direct knowledge testing.
Nature or patterns of interaction with a user interface. For example, by monitoring user interface usage, background audio or activity, a determination may be made as to whether a user is acting seriously and conscientiously, or alternately the user is “mucking about”.
User data benchmarked against “normal” data ranges. This is optionally applied in respect of known user data, and data inputted by a user (for example inputs for a modelling process). In the case that a user's values are outside of normal ranges, that may count against appropriateness for automated advice. In some cases prescribed attributes are defined with automatically discount a user from being eligible to access the computer-generated advice.
Identification of deemed “unrealistic expectations”. For example, in embodiments where a user inputs values for modelling process, an algorithm is applied to determine whether those inputs are representative of a realistic expectation (a subjective notion that is defined in terms of objective data attributes).

In some embodiments, where access to computer-generated advice is withheld, the user is provided with feedback to assist in improving their rating. For example, suggestions are made in respect of content that should be reviewed, and so on.

In practice, controlling of access to services may be used in isolation, or in a similar manner to competency scores as described further above as an additional hurdle before certain content becomes accessible. Several examples are provided below.
Medical treatment. As a user develops a greater understanding of underlying concepts, health, and/or treatment risks, the user is provided with additional information and medical treatment advice. For example, in one embodiment a prescription for medication is able to be obtained once a user has passed a risk assessment step. This may require that (i) the user has demonstrated by way of interaction with the online environment that they have adequate competencies in relevant topics; (ii) inputs provided in respect of symptoms, prior conditions and the like fall within benchmarked ranges; (iii) demographic and/or segmentation data does not lead to the user being categorized as a particular risk; and (iv) other factors. The risk assessment provides an objective means to automatically assess whether to be trusted to use the medication safely in an educated and sensible fashion prior to issuing an automated prescription.
Equipment maintenance. A user is provided with information that assists in performing more complex maintenance tasks only where they have demonstrated competency (for example through interaction with content) in respect of simpler underlying tasks of which prior competency is recommended. A risk assessment may be provided where the online environment provided functionality to actually control or alter physical equipment (for example via a computer controlled component that interfaces with the equipment).
Financial advice, such as in the context of superannuation. Content of increasing complexity regarding financial management is delivered to a user over time based on observation and updating of competency levels, to better ensure that the user is able to understand concepts and reasons underlying suggestions and/or advice. A risk assessment may be provided to restrict access to a service whereby a suggested investment plan is able to be implemented in practice.
General education. Competency scores are used to enable a more graduated system of ensuring a user has adequate prerequisite knowledge for a particular course or content based upon monitoring of what a user has learned (or demonstrated knowledge of) via their use of the online environment. A risk assessment may be provided as a barrier to being provided an automatically generated certification of completion of a course or the like.

It will be appreciated that these are examples only.

Generation of Graphical Displays for Complex Modelling Scenarios

Modules 103 are additionally configured to generate data to enable rendering of a graphic at a client terminal thereby to simplistically represent the otherwise complex modelling outcomes. The graphic is, in one embodiment, of the nature shown in FIG. 4C.

Each of the graphics illustrated in FIG. 4C are representative of a one-dimensional distribution from a worst forecasted outcome to a best forecasted outcome (with example 430 having tow one-dimensional distributions). By “one-dimensional”, what is meant is that the distribution has a dimension progressing from a worst outcome forecasted to a best outcome forecasted. In the illustrated example, the worst is represented by the bottom of the bar, and the best is represented by the top of the bar. Values are optionally provided (for example by labels and/or an axis). The term “one-dimensional” does not refer to the nature of a bar, for example a 3 dimensional object may be used to represent a one-dimensional distribution.

The graphic further including visual delimiters representative of at least two statistical probability levels, thereby to graphically distinguish three segments of the distribution. The three segments are portions 412, 413 and 414 (and in example 420, additionally 412′, 413′ and 414′). The underlying essence is to show a range of most likely outcomes (413), and ranges of less likely outcomes (412 and 414). By way of example, this is optionally achieved by setting the two statistical probability levels to include: (i) a first level between 99% and 80%, and a second level between 1% and 20%. In the illustrated embodiment 95% and 5% are used. This enables a simplified representation to a user of outcomes that are only 5% likely as unlikely outliers, and a range in which there is 90% certainty of an outcome (based on the modelling performed).

In the examples at 420 and 430, the graphic further includes value markers derived from values inputted by the user. These are in the form of dashed lines 418 and 419 traversing the bar at a normal to the axis of the bar. In some embodiments these are used to show a user-defined minimal acceptable outcome value, and a user-defined preferred outcome value. These are able to be readily visually compared with the segments, thereby to understand rough likelihood of those values being realized. For example, in the example at 420 the upper value 418b is in the top 5% range, suggesting that it is unlikely. The lower value 419 is in the lower 5% range, suggesting that to also be unlikely. If these respectively represent a desired outcome and minimum acceptable outcome, the graphic clearly and simply shows that it is over 95% likely that the minimum acceptable value would be realized, but under 5% likely that the desired value would be realized.

The example at 430 provides two distributions. One (segments 412, 413 and 414) is based upon a current strategy derived from values inputted by the user via the user interface, the values being representative of the current strategy. The other (segments 412′, 413′ and 414′) is based upon a proposed strategy derived from (i) values inputted by the user via the user interface, the values being representative of desired values; and (ii) analysis of results derived from a selected one of a plurality of available strategy models. The example at 430 indicates that all modelled outcomes surpass the minimum acceptable value, and that there is a reasonable probability of reaching the desired value.

FIG. 4D to FIG. 4H illustrate graphical objects according to further embodiments, these providing similar components to that of FIG. 4C.

In some embodiments, the selected one of the plurality of available strategy models is selected by a process including determining forecasted outcomes for a plurality of the available strategy models, and selecting a model for which at least one of the values representative of desired values falls within a defined region of the distribution.

In one embodiment, a software platform (for example a software platform that provides a graphical user interface that is rendered at a client terminal via a web browser) provides a user with access to modelling simulations that execute at a server. The server is configured to execute one or more probabilistic simulations, the simulations being configured to execute on the basis of a set of variable parameters. The user interface provides inputs that are configured to obtain, from the user, data that enables setting of the variable parameters for the simulations. The variables might be set directly by the user or indirectly using data about the user along with other data obtained from other sources. These include: (i) values representing attributes of a strategy being implemented by the user; and (ii) values representing the user's attributes and objectives (directly or indirectly obtained and/or inferred), and (iii) data that is independent of the user (e.g., mortality data, pension rules, tax rates, health policy, economic indicators/factors, etc). Each of the inputs will have a probability distribution. This distribution might be as simple a single data point with 100% probability, a normal distribution, uniform distribution, or any other probability distribution defined by formula or histogram. For example, in the context of a retirement investment plan, the data could include information describing the user's current investment strategy, information relevant to retirement age, life expectancy, and desired retirement income, cohort information, asset class returns, economic scenario modelling, health and mortality data, etc.

Following setting of the variable parameters, in response to user input, the probabilistic simulation is executed a sufficient number of times to provide a statistically stable outcome to an acceptable level of confidence. At one extreme, if the inputs are all single points with 100% confidence and/or the calculations can be appropriately resolved using closed-from mathematics then a single calculation may be sufficient. If there are many degrees of freedom and a pure monte-carlo technique is employed, many thousands of calculations may be required It will be appreciated that, as the number of probabilistic functions in a simulation increases, as does the range of potential outcomes (and complexity). Each execution of the probabilistic simulation results in an outcome, and the collection of outcomes defined a statistical distribution. In some embodiments, the simulations include monte-carlo simulations. In one implementation, in the space of retirement planning, the simulations are configured to solve for an income target derived from the user's input (for example an annual retirement income from investments).

The statistical distribution resulting from execution of the probabilistic simulations is converted into a graphical form, as described above. That is, the outcomes are represented along a first axis having a defined dimension, and visual delimiters inserted to show least two statistical probability levels, thereby to graphically distinguish three segments of the distribution, (for example 95% and 5% are used, enabling simplified representation of outcomes that are only 5% likely as unlikely outliers, and a range in which there is 90% certainty of an outcome (based on the modelling performed).

The above example provides a representation of results from a probabilistic simulation that has parameters representative of a current strategy, as derived from user input. In some cases, a plurality of further probabilistic simulations are also executed, these having parameters representative of (i) respective predefined alternate strategies; and (ii) the same values representing the user's attributes and objectives. Each further probabilistic simulation is repeatedly executed to provide a respective statistical distribution of outcomes. These are also able to be viewed by a similar form of graphic representation, thereby to enable visual comparison of both a range of potential outcomes, and segmented statistical probabilities of those outcomes using the 95% and 5% delimiters. Accordingly, this enables side-by-side comparison of different strategies based on a common set of user objectives and attributes, but different strategies.

In certain embodiments, the user objective data is used to filter strategies in respect of which probabilistic simulations have been executed, thereby to find one or more “best” strategies. The definition of “best” is based upon one or more rules that enable ranking of strategies based on relationships between (i) user desired outcomes derived from the user input; and (ii) simulated outcome values falling in a defined range of a probabilistic distribution. For example, the ranking may be based upon extent of exceedance of user desired outcome values within the central 90% probability distribution range. The filtering, in some embodiments, results in selection of only a single best strategy, and a comparison graphic is defined only for that best strategy (and displayed for comparison with the existing strategy, for example as shown in FIG. 4C).

Exemplary Client-Server Framework

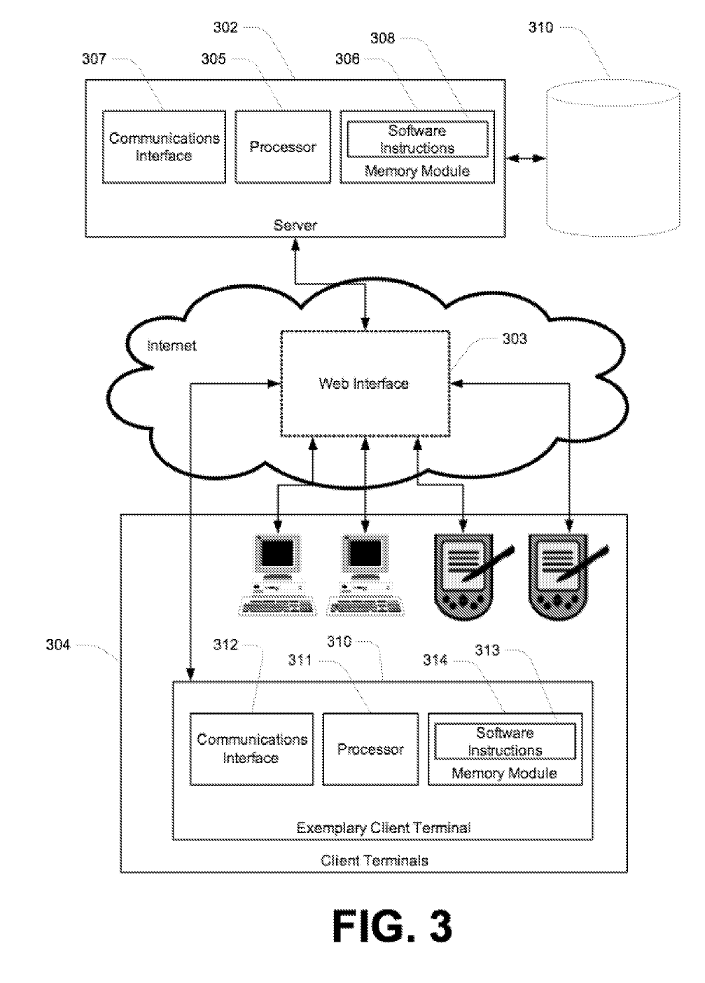

In some embodiments, methods and functionalities considered herein are implemented by way of a server, as illustrated in FIG. 3. In overview, a web server 302 provides a web interface 303. This web interface is accessed by the parties by way of client devices 304. In overview, users access interface 303 over the Internet by way of client devices 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client device. In some embodiments, a website is a source of information made available by a server and accessible over the Internet by a web-browser application running on a client device. The web-browser application downloads code, such as HTML code, from the server. This code is executable through the web-browser on the client device configured to provide a graphical and often interactive representation of the website on the client device. By way of the web-browser application, a user of the client device is able to navigate between and throughout various web pages provided by the website, and access various functionalities that are provided.

Although some embodiments make use of a website/browser-based implementation, in other embodiments proprietary software methods are implemented as an alternative. For example, in such embodiments client devices 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

Interpretation

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data (e.g., from registers and/or memory) to transform that electronic data into other electronic data that may be stored (e.g., in registers and/or memory). A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display (e.g., a liquid crystal display (LCD), Electrophoretic Display (EPD), or a cathode ray tube (CRT) display) may be included. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements (e.g., several steps), no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected (e.g., networked to other processor(s)) in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions (e.g., a computer program) that is for execution on one or more processors (e.g., one or more processors that are part of web server arrangement). Thus, as will be appreciated by those skilled in the art, embodiments of the present disclosure may be embodied as a method, an apparatus such as a special purpose apparatus, an apparatus such as a data processing system, or a computer-readable carrier medium (e.g., a computer program product). The computer-readable carrier medium carries computer readable code including a set of instructions that when executed on one or more processors cause the processor or processors to implement a method. Accordingly, aspects of the present disclosure may take the form of a method, an entirely hardware embodiment, an entirely software embodiment or an embodiment combining software and hardware aspects. Furthermore, the present disclosure may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present disclosure. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data—communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

It should be appreciated that in the above description of exemplary embodiments of the disclosure, various features of the disclosure are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the disclosure.

In the description provided herein, numerous specific details are set forth. However, it is understood that embodiments of the disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the various embodiments of the disclosure, those skilled in the art will recognize that other and further modifications may be made thereto without departing from the spirit of the disclosure, and it is intended to claim all such changes and modifications as falling within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The invention is claimed as follows:

1-95. (canceled)

96: A computer system configured to configure a dynamically adapting user interface configured to be delivered to a plurality of client devices, the computer system including:
a user interface management module that enables user-generation of a plurality of rules, including:
a plurality of user activity rules configured to:
(i) identify a plurality of predefined interactions between a user and the user interface; and
(ii) in response to identification of a designated one of the predefined interactions between the user and the user interface, update a plurality of interaction-derived values associated with the user based on at least one of the user activity rules associated with that designated one of the predefined interactions; and
interface customization rules configured to:
(i) process the updated plurality of interaction-derived values; and
(ii) configure the user interface to control, based on at least the processed updated plurality of interaction-derived values associated with the user, delivery of at least one of: content and user interface functionality.

97: The computer system of claim 96, wherein the user interface management module provides a graphical user interface that enables the user to build a plurality of rules from available rule artefacts and logical operators;
wherein the rules are implemented via a user interface delivery module configured to deliver the user interface to the plurality of client devices, the user interface delivery system including:
a user identification module configured to identify the user who accesses a user interface at one of the plurality of client devices;
a user interface monitoring module configured to interact with the user identification module and to monitor interactions between the user and the user interface;
a user activity component configured to operate a user activity rules engine operable to implement the user activity rules; and
an interface customization component configured to operate an interface customization rules engine operable to implement the interface customization rules.

98: The computer system of claim 97, wherein the interface customization rules engine is operable to execute rules configured to: (i) process the plurality of interaction-derived values associated with the user; (ii) process attributes associated with the user; and (iii) configure, based on a combination of (i) and (ii), the user interface to enable provision of at least one of: specified content and user interface functionality.

99: The computer system of claim 96, wherein configuring the user interface to control delivery of at least one of: the content and the user interface functionality includes providing access to automatically generated advice.

100: The computer system of claim 96, further comprising a machine learning component configured to operate a machine learning process to autonomously define new rules that reference: (i) the plurality of interaction-derived values; (ii) attributes associated with the user; and (iii) provision of at least one of: specified content and user interface functionality.

101: A computer system configured to control access to services delivered in an online environment, the system including:
a user data management module configured to maintain a repository of user data, wherein the user data includes, for each user:
(i) data representative of user personal attributes;
(ii) data values inputted by the user via objects defined in the online environment; and
(iii) data representative of content accessed via the online environment;
a rating module that is configured to interact with the user data management module to perform a rating process that defines a rating for a designated user based on a processing of data from the data representative of user personal attributes, the data values inputted by the user via objects defined in the online environment, and the data representative of content accessed via the online environment; and
a service access control determination module configured to:
(i) responsive to the defined rating meeting threshold conditions for the designated user, provide the designated user with access to a controlled service via the online environment; and
(ii) responsive to the defined rating failing to meet the threshold conditions for the designated user, prevent the designated user from accessing the controlled service via the online environment.

102: The computer system of claim 101, further comprising a rating trigger module configured to, in response to predefined conditions being met by the designated user, trigger the rating process.

103: The computer system of claim 101, wherein the controlled service comprises a delivery of computer-generated advice.

104: The computer system of claim 101, wherein the defined rating comprises an advice risk rating.

105: The computer system of claim 101, wherein the data representative of content accessed via the online environment includes data representative of interactions with one or more content segments.

106: The computer system of claim 105, wherein the interactions with one or more content segments comprises responses to a call-to-action delivered by a designated content page.

107: The computer system of claim 101, wherein the data representative of content accessed via the online environment includes one or more competency scores derived from processing of data representative of interactions with one or more content segments.

108: The computer system of claim 101 further comprising a repository of user data, wherein the user data further comprises, for each user, data representative of interactions between the user and a user interface, and the defined rating for the designated user is further based on the user data further comprises data representative of interactions between the designated user and a user interface

109: A computer-implemented method for controlling access to services delivered in an online environment, the method including:
maintaining a repository of user data, wherein the user data includes, for each user:
(i) data representative of user personal attributes;
(ii) data values inputted by the user via objects defined in the online environment;
(iii) data representative of content accessed via the online environment;
in response to a plurality of predefined conditions being met by a designated user, triggering a rating process that defines a rating for the designated user based on processing of data from the data representative of user personal attributes, the data values inputted by the user via objects defined in the online environment, and the data representative of content accessed via the online environment;
responsive to the defined rating meeting threshold conditions for the designated user, providing the designated user with access to a controlled service via the online environment; and
responsive to the defined rating failing to meet the threshold conditions for the designated user, preventing the designated user from accessing the controlled service via the online environment.

110: The computer-implemented method of claim 109, wherein the controlled service comprises a delivery of computer-generated advice.

111: The computer-implemented method of claim 109, wherein the rating comprises an advice risk rating.

112: The computer-implemented method of claim 109, wherein the data representative of content accessed via the online environment comprises data representative of interactions with one or more content segments.

113: The computer-implemented method of claim 112, wherein the interactions with one or more content segments comprises responses to a call-to-action delivered by a designated content page.

114: The computer-implemented method of claim 109, wherein the data representative of content accessed via the online environment comprises one or more competency scores derived from processing of data representative of interactions with one or more content segments.

115: The computer-implemented method of claim 109, further comprising maintaining a repository of user data, wherein the user data further comprises data representative of interactions between the user and a user interface and the defined rating for the designated user is further based on the user data further comprises data representative of interactions between the designated user and a user interface.
